(19) United States
(12) Patent Application Publication
(10) Pub. No.: US 2026/0093939 A1
(43) Pub. Date: Apr. 2, 2026

(54) LOCATING DEVICE

(71) Applicant: ASTER Labs, Inc, Shoreview, MN (US)

(72) Inventors: Chuck Satoshi Hisamoto, Woodbury, MN (US); Suneel Ismail Sheikh, Shoreview, MN (US); Mark Charles Olander, Minneaplois, MN (US); Jonah Phillip Roux, North Branch, MN (US); Daniel Lawrence Joynt, Columbus, MN (US)

(21) Appl. No.: 19/325,034

(22) Filed: Sep. 10, 2025

Related U.S. Application Data
(60) Provisional application No. 63/693,271, filed on Sep. 11, 2024.
(60) Provisional application No. 63/695,440, filed on Sep. 17, 2024.

(51) Int. Cl. G06K 7/10; A61C 13/08; G06K 19/077

(52) U.S. Cl. CPC G06K 7/10316; A61C 13/08; G06K 19/07773; A61C 2204/005

(57) ABSTRACT

A system for helping an end-user locate a denture that can include a passive antenna configured to generate a resonant response by resonating at a resonance frequency when subjected to an external radio frequency signal. The system can include a portable detector unit configured to emit the external radio frequency signal and to detect the resonant response from the passive antenna. The portable detector unit can include a signal generator to generate and transmit the external radio frequency signal. A signal receiver can receive the resonant response from the passive antenna within the denture. A memory can include instructions and a controller can be coupled to the memory. The instructions can be configured to cause the processing circuitry to perform operations that can include determining, based on the resonant response, an indication of a location of the denture. Transmit guidance to direct the end user toward the denture.

### TECHNICAL FIELD

The present disclosure relates to a locating device. More specifically, the present disclosure relates to a locating device for finding devices, including a passive antenna.

### BACKGROUND

Increasingly frequent and common misplaced and lost dentures in private homes and care facilities have significant implications for the wearer and caregiver regarding oral health impact, cost, and emotional stress. In addition to neuromuscular associations being lost from an original prosthesis, emotional frustration, conflict, and financial expense often arise due to lost usage time for the patients and caregivers.

### BRIEF DESCRIPTION OF THE DRAWINGS

Various examples are illustrated in the figures of the accompanying drawings. Such examples are demonstrative and not intended to be exhaustive or exclusive examples of the present subject matter.

FIG. 1 illustrates a perspective view of an example of a system, including a locating device and an object, including a passive antenna.

FIG. 2 illustrates a schematic diagram of an example of a locating device.

FIG. 3 illustrates a schematic diagram of an example of a system of an example locating device.

FIG. 4 illustrates a schematic diagram of an example of a locating device communicating with an example of a lost object.

FIG. 5 illustrates an example of a method for finding a lost object with an example locating device.

FIG. 6 illustrates a graphical representation of an example of a ring-down signal.

FIG. 7 illustrates an example graphical user for an example of a locating device.

FIG. 8 illustrates a perspective view of an example of an object, including an example passive antenna.

FIG. 9 illustrates a top view of an example of a passive antenna.

FIG. 10 illustrates a top view of an example of a passive antenna.

FIG. 11 illustrates a schematic diagram of an example of a method.

FIG. 12 illustrates a block diagram illustrating an example of a machine upon which one or more examples can be implemented.

FIG. 13 illustrates one or more examples of a passive antenna.

### DETAILED DESCRIPTION

For the 35 million Americans, primarily older adults, with no remaining natural teeth, and 178 million with at least one tooth missing, the use of removable dentures can have many benefits, including improved mastication, nutritional intake, speech, and appearance, as well as social interaction and emotional confidence. Conversely, misplacing or losing dentures can have significant detrimental effects, including reduced oral functional status, high replacement cost, emotional stress, and frustration. Denture use is a complex learned skill, and wearers are often unable to quickly adapt to replacement dentures, especially if they have worn previous ones for many years or have disorders affecting neuromuscular function, such as dementia, stroke, or Parkinson's disease, among others. Caregivers in long-term care facilities and hospitals commonly report episodes of lost dentures due to the high prevalence of patient disability and dependency on caregivers who may be unfamiliar with managing dental prostheses. When dentures are lost, often after being removed and placed on meal trays, in napkins or tissues, or the laundry, the caregivers and facilities are directly blamed for the loss by the patients and their families. While families may ultimately be financially responsible for replacing the dentures, these frequent scenarios create immense emotional frustration and potential conflict for all parties involved. Many tagging and location technologies for simple objects (e.g., keys) frequently require power and recharging, which poses a risk for dentures inside a patient's mouth. Therefore, an unmet need exists to support denture-wearing adults, especially older adults, and their caregivers by providing a safe, passive, low-cost, rapid, and highly effective lost denture locating system to locate and recover the prostheses successfully.

Dentures or other objects being lost are not only a problem in clinical settings as they can also cause issues and frustrations within single-family homes. People of all cognitive abilities lose objects, and some objects, such as dentures, glasses, remote controllers, or the like can cause additional frustrations because of their difficulty in locating these objects. For example, dentures can be small and fragile. Thus, when they are lost, they can be difficult to find and easily broken. Glasses can be hard to locate as most users need their glasses to be able to see clearly, so lost glasses can be easily broken when they are lost. These are just example objects and are not intended to be limiting the scope of the present disclosure. The inventors of the present disclosure appreciate there are many additional use cases for the systems and methods disclosed here.

The present disclosure relates to a fully embedded, miniature, and safe locating solution using an antenna that can be entirely passive, can operate without power inside the denture itself, and can be easily enclosed in the denture base substrate. The antenna can be located via a small handheld detector that the user (e.g., caregivers, family, staff, the denture wearer, or the like) operates. The detector can operate using low-frequency radio wave harmonic reflection and multiplication techniques. The handheld detector unit can be accompanied by a user-friendly smartphone mobile application to guide and assist the caregiver in quickly and efficiently searching for and locating the lost denture. The goal is to increase success rates of locating lost dentures while giving denture wearers, families, and staff at care facilities and hospitals the confidence and peace of mind that these important prostheses can be located, if lost, thus minimizing the financial, physical, and emotional consequences of fabricating and adapting to new dental prostheses.

In examples, a system for helping an end-user locate a denture can include a passive antenna. The passive antenna can be embedded within the denture and can be configured to generate a resonant response by resonating at a resonance frequency when subjected to an external radio frequency signal. The system can include a portable detector unit configured to emit the external radio frequency signal and to detect the resonant response from the passive antenna. The portable detector unit can include a signal generator to generate and transmit the external radio frequency signal. A signal receiver can receive the resonant response from the passive antenna within the denture. The system can also include a memory including instructions and a controller coupled to the memory. The instructions, when performed by processing circuitry of the controller, can be configured to cause the processing circuitry to perform operations that can include determining, based on the resonant response, an indication of a location of the denture. Then, guidance can be transmitted to a user of the system to direct the user toward the denture.

In examples, a system can include a denture including a passive antenna. The passive antenna can be embedded within the denture (or other object) and configured to generate a resonant response by resonating at a resonance frequency when subjected to an external radio frequency signal. A portable detector unit can be configured to emit the external radio frequency signal and detect the resonant response from the passive antenna. The portable detector unit can include a signal generator to generate and transmit the external radio frequency signal. The portable detector unit can also include a signal receiver to receive the resonant response from the passive antenna within the denture. The system can also include a memory including instructions and a controller coupled to the memory. The instructions, when performed by processing circuitry of the controller, can be configured to cause the processing circuitry to perform operations. Such operations can include determining, based on the resonant response, an indication of a location of the denture. Then guidance can be transmitted to a user of the system to direct the user toward the denture.

The above discussion is intended to provide an overview of subject matter of the present patent application. It is not intended to provide an exclusive or exhaustive explanation of the invention. The description below is included to provide further information about the present patent application.

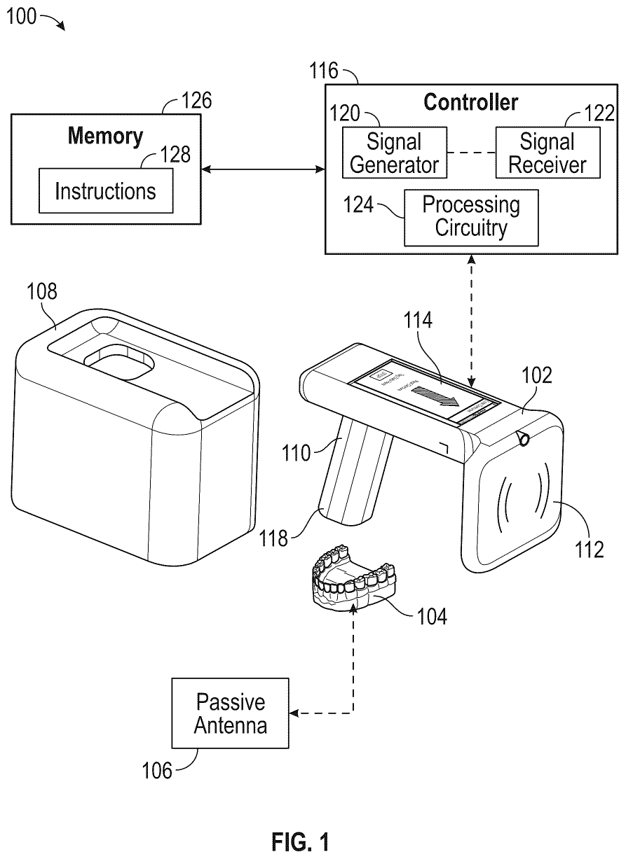

FIG. 1 illustrates a perspective view of an example of portions of a system 100, including a portable detector unit 102, and an object (e.g., an object 104), including a passive antenna 106. The system 100 can be used to track and find objects. For example, the system 100 can be used in senior living facilities to help patients and staff find commonly lost objects around the facility. The system 100 can also be used elsewhere and to find other known objects, such as glasses, television remotes, headphones, wallets, any other object that can include a passive antenna, or the like.

The portable detector unit 102 can be a handheld device to help an end-user find the lost object. For example, the portable detector unit 102 can be a handheld device that is configured to be inserted into the charging base 108 for charging a battery onboard the portable detector unit 102. In other examples, the portable detector unit 102 can be a personal mobile device, a laptop computer, or an accessory attached to a personal mobile device or a laptop computer. The portable detector unit 102 can include a handle 110, a signal generating and receiving end 112, a user interface 114, and a controller 116.

The handle 110 can be configured to be held by an end-user of the portable detector unit 102. The handle 110 can include ergonomic designs to help reduce user fatigue while using the portable detector unit 102. For example, a diameter of the handle 110 can be configured to fit within a standard adult hand such that the average end-user can comfortably hold onto the portable detector unit 102. A distal portion of the handle 110 can include an inductive charging interface 118. The inductive charging interface 118 can engage with the charging base 108 to convey a charge to a batter installed within the portable detector unit 102. The inductive charging interface 118 can include plates, pins, springs, or any other conductive formation configured to receive a charge from the charging base 108.

The signal generating and receiving end 112 can be opposite the portable detector unit 102 from the handle 110. In examples, the signal generating and receiving end 112 can include features to help transmit the signal (e.g., transparent or thinner portions to permit transmission of the signal from a signal generator 120) and features to gather signals (e.g., features or formations configured to collect or redirect received signals toward a signal receiver 122).

The user interface 114 can be configured to communicate with the user and the controller 116. The user interface 114 can guide the end-user toward the lost object. As shown in FIG. 1, the user interface 114 can extend between the handle 110 and the signal generating and receiving end 112. The user interface 114 can include a liquid crystal display (LCD), light emitting diode (LED), organic light emitting diode (OLED), electrophoretic displays (e-ink), plasma display panels (PDP), vacuum fluorescent displays (VFD), electroluminescent displays (ELD), digital light processing (DLP), or any combination thereof. The user interface 114 can be configured to receive instructions from the end-user to start the device-finding sequence and communicate with the end-user to help find the lost device.

The controller 116 can include or communicate with the user interface 114, processing circuitry 124, a signal generator 120, and a signal receiver 122. The controller 116 can receive user inputs from the user interface 114 and, based on those inputs, send control signals to one or more of the user interface 114 or the signal generator 120 to find lost objects. The signal generator 120 can generate and transmit an external radio frequency signal. The signal receiver 122 can receive the resonant response from a passive antenna 106 of the object 104.

The controller 116 can be coupled to a memory 126, including instructions 128. The instructions 128, when executed by the processing circuitry 124 can cause the processing circuitry 124 to perform operations. For example, the instructions 128, when performed by the processing circuitry 124, can cause the processing circuitry 124 to determine, based on the resonant response, an indication of a location of the object (e.g., object 104). The instructions 128, when performed by the processing circuitry 124 can also cause the processing circuitry 124 to transmit guidance to a user of the system 100 to direct the user toward the object 104.

The charging base 108 can include one or more batteries configured to store a charge and convey the charge to the portable detector unit 102 upon coupling the portable detector unit 102 to the charging base 108. The charging base 108 can also include a power adapter configured to plug into an outlet and convey a charge to the portable detector unit 102 attached to the charging base 108.

The system 100 can provide an easy-to-use solution to help end-users find lost objects that can include an embedded antenna. As the system 100 knows the passive antenna, the system 100 can detect the resonant response of the external radio frequency signal and guide the end-user toward the object. The system 100 can help reduce missing objects, which can reduce many frustrations for workers in medical facilities, including memory care facilities, and many other industries.

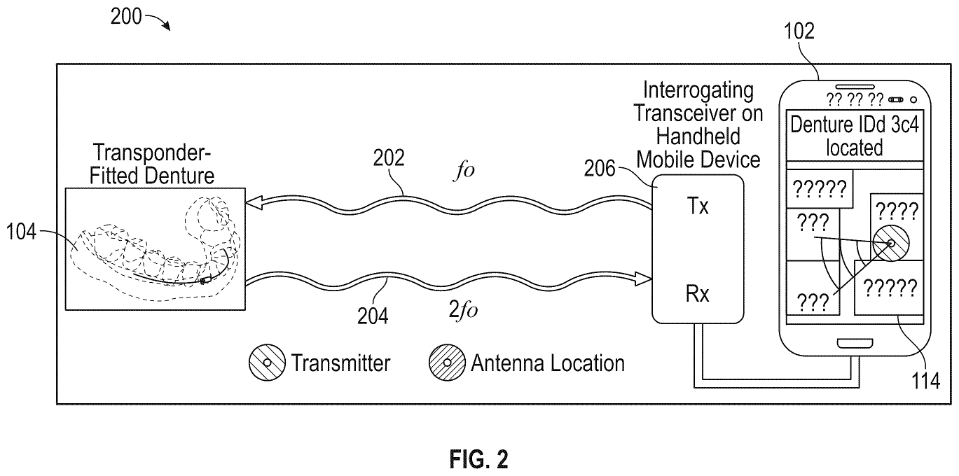

FIG. 2 illustrates a schematic diagram of an example of portions of a system 200 (e.g., the system 100, see FIG. 1). The system 200 can find lost objects around an environment by transmitting a signal and receiving a signal reflected by the lost object. The system 200 can then direct a user of the system 200 toward the lost device on a graphical user interface. In examples, the system 200 can include a portable detector unit 102 and an object 104.

The object 104 can include a passive antenna (e.g., passive antenna 106, see FIG. 1) that can transform the transmitted signal 202 to generate the resonant response 204. As the antenna is passive, the portable detector unit 102 can find the object 104 without a power source connected to the object 104. As shown in FIG. 1, the object 104 can include the object 104. In other examples, object 104 can be glasses, television remotes, electronic devices, phones, wallets, keys, or any other object that can be lost and can include a passive antenna embedded. For example, the object 104 can include glasses that include a passive antenna embedded in the frame of the glasses. The object 104 can include frisbee golf discs that include one or more embedded passive antennas to help end-users locate lost devices in their playing environments. The samples of object 104 listed herein are just examples and are not, in any way, intended to be limiting to the scope of object 104 that baseline technology of system 100 can help an end-user locate.

The portable detector unit 102 can be a personal mobile device (e.g., phone, tablet, computer, or the like) configured to find lost objects including embedded passive antennas. The portable detector unit 102 can include a user interface 114 (e.g., user interface 114, see FIG. 1) to help guide the user of the portable detector unit 102 toward the lost object (e.g., object 104). As shown in FIG. 2, the user interface 114 can include a map with directional guidance to guide the user toward the object. Moreover, the location of the portable detector unit 102 and the object 104 can be shown on the device. As such, the portable detector unit 102 can be programmed to include an interior map of the environment that the object is used within to help provide better direction to the user. For example, the portable detector unit 102 can be used in an apartment, room, condo, or the like of patients in assisted living or memory care communities, and the portable detector unit 102 can include a floor plan of the living quarters of the patient to help the user of the portable detector unit 102 more quickly find the object 104.

The portable detector unit 102 can be connected to a transceiver 206. The transceiver 206 can be configured to generate a transmitted signal 202 and receive a resonant response 204. The transmitted signal 202 and the resonant response 204 can include external radio frequency signals. In examples, the transceiver 206 can be an interrogator transceiver such that the transceiver 206 is a single device that generates the transmitted signal 202 and receives the resonant response 204. In another example, the transceiver 206 can be two or more devices combined to generate one or more transmitted signals 202 and receive one or more resonant responses 204. The transceiver 206 can be connected to the portable detector unit 102 via a wire, as shown in FIG. 2, or can be wirelessly connected (e.g., via Bluetooth, WIFI, or the like) to the portable detector unit 102. The portable detector unit 102 can include software that deciphers the transmitted signal 202 and the resonant response 204 to determine a location of the object 104 relative to the portable detector unit 102 to help guide the user of the portable detector unit 102 toward the object 104.

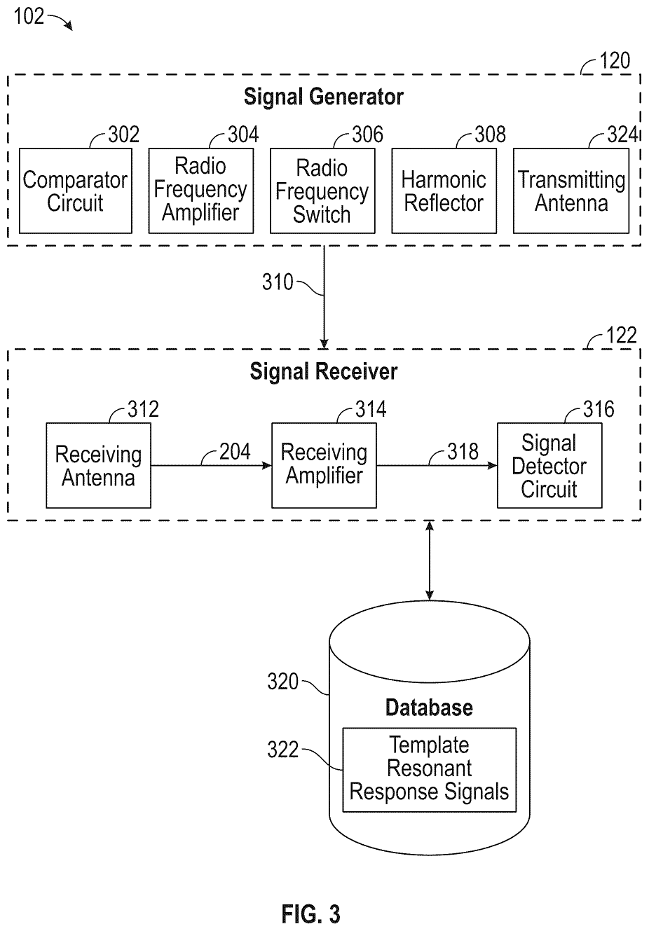

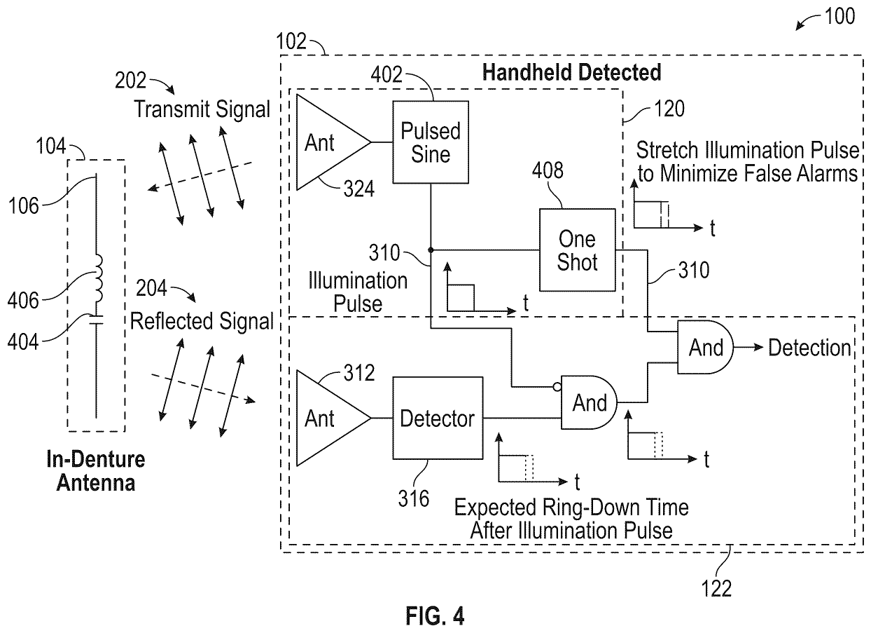

FIG. 3 illustrates a schematic diagram of an example of portions of the signal generator 120 and the signal receiver 122 of an example of the portable detector unit 102. As discussed herein, the signal generator 120 can be configured to generate an external radio frequency signal (e.g., the transmitted signal 202, see FIG. 4), and the signal receiver 122 can be configured to receive external radio frequency signals (e.g., the resonant response 204, see FIG. 4).

The signal generator 120 can include a comparator circuit 302, a radio frequency amplifier 304, a radio frequency switch 306, and a harmonic reflector 308. The comparator circuit 302 can be configured to transform the external radio frequency signal into a sine wave to generate the pulsed sine signal 402. In other examples, the comparator circuit 302 can transform the external radio frequency signal into a continuous (e.g., non-pulsed) pulsed sine signal. The transformation of the external radio frequency signal into the sine wave can help reduce noise in the external radio frequency signal to help the signal receiver 122 find the reflected signal (e.g., the resonant response 204, see FIG. 2).

The radio frequency amplifier 304 can be configured to amplify (e.g., increase an intensity or a magnitude of the radio frequency signal). The radio frequency amplifier 304 can increase the intensity of the radio frequency signal by increasing the current or voltage of the radio frequency signal. The radio frequency amplifier 304 can increase the intensity of the radio frequency signal by increasing the voltage and the current of the radio frequency signal. The radio frequency amplifier 304 can alter the amplification of the radio frequency signal as the device is trying to find the lost object. For example, the radio frequency amplifier 304 can increase the intensity to a minimum set intensity as the portable detector unit 102 begins searching for the object 104. If the resonant response 204 is not found, the radio frequency amplifier 304 can further increase the intensity of the radio frequency signal at set increments until the resonant response 204 is detected by the signal receiver 122.

The radio frequency switch 306 can alter a frequency of the external radio frequency signal. Altering the frequency can help avoid interference of various systems within and around the environment where the portable detector unit 102 is being used to find the object 104. By altering the external radio frequency signal, the radio frequency switch 306 can help the signal receiver 122 focus on certain frequencies to help the efficiency in finding the resonant response 204.

The harmonic reflector 308 can be configured to generate a reflected external radio frequency signal 310 and transmit the example of the resonant response 204 to the signal receiver 122. The reflected external radio frequency signal 310 can be an example of radio frequency anticipated for the resonant response 204. For example, the signal receiver 122 can utilize the reflected external radio frequency signal 310 to predict the pulse frequency of the resonant response 204. To generate the reflected external radio frequency signal 310, the harmonic reflector 308 can receive the external radio frequency signal, generate a reflected external radio frequency signal 310 based on the known capacitor 404 and inductor 406 of the passive antenna 106, and transmit the reflected external radio frequency signal 310 to the signal receiver 122. The signal receiver 122 can compare the reflected external radio frequency signal 310 to the received signals to find the resonant response 204 and find the object 104 within the environment.

The signal receiver 122 can be configured to receive external radio frequency signals and determine when the resonant response 204 is found. The signal receiver 122 can include the receiving antenna 312, a receiving amplifier 314, and a signal detector circuit 316 (e.g., the signal detector circuit 316).

The receiving amplifier 314 can receive the resonant response 204 and amplify (e.g., alter a voltage or current of the signal) to change the intensity of the resonant response 204 and generate the amplified resonant response signal 318. The signal detector circuit 316 can use the amplified resonant response signal 318 to find the object 104 and determine a location of the object 104 relative to the portable detector unit 102.

A database 320 can be in communication with the signal receiver 122. The database 320 can include template resonant response signals 322. The template resonant response signals 322 can be stored reference signals of known response signals for the various objects (e.g., the object 104, see FIG. 1) programmed to be found by the portable detector unit 102. The signal detector circuit 316 can compare the reflected external radio frequency signal 310 and the template resonant response signals 322 to the amplified resonant response signal 318 to verify the specified object (e.g., object 104) is reflecting the amplified resonant response signal 318.

The reflected external radio frequency signal 310 and the template resonant response signals 322 can help the signal detector circuit 316 focus on the specified signal to help determine the location of the object 104 relative to the portable detector unit 102. In examples, the instructions 128 (FIG. 1) can be configured to cause the controller 116 (FIG. 1) to compare the digital resonant response signal (e.g., the amplified resonant response signal 318) to one or more of the template resonant response signals (e.g., template resonant response signals 322 or the reflected external radio frequency signal 310). The instructions 128 can also configure the controller 116 to generate an alert on condition that the digital response signal matches at least one of the template resonant response signals. For example, the alert can be indicative that the specified object (e.g., the object 104, see FIG. 1) is detected and the portable detector unit 102 will start directing the user toward the object 104.

In other words, the signal detector circuit 316 can use the reflected external radio frequency signal 310 to anticipate a pulse frequency of the resonant response 204 and the template resonant response signals 322 to determine the expected changes between the resonant response 204 and the transmitted signal 202 based on interactions of the transmitted signal 202 and the passive antenna 106. Thus, the reflected external radio frequency signal 310 and the template resonant response signals 322 help the signal detector circuit 316 more quickly identify and isolate the transmitted signal 202 to efficiently guide the end-user toward the object 104 (FIG. 1).

FIG. 4 illustrates a schematic diagram of an example of portions of a locating device (e.g., portable detector unit 102) communicating with an example of a lost object (e.g., the object 104). As discussed herein, the portable detector unit 102 can include the signal generator 120 and the signal receiver 122. The signal generator 120 can generate a single shot signal 408 or a pulsed sine signal 402. The single shot signal 408 can include a single external radio frequency signal at a set time interval. The pulsed sine signal 402 can be a sinusoidal external radio frequency signal extending for a set time interval. In examples, the signal generator 120 can alternate between transmitting the single shot signal 408 and the pulsed sine signal 402. In examples, the signal generator 120 can generate a transmitted signal 202 that combines the single shot signal 408 and the pulsed sine signal 402. The signal generator 120 can also include a transmitting antenna 324 to transmit the single shot signal 408 or the pulsed sine signal 402 as a transmitted signal 202 (e.g., transmitted signal 202, see FIG. 2). As discussed herein, the reflected external radio frequency signal 310 can send both the single shot signal 408 and the pulsed sine signal 402 to the signal detector circuit 316 to help the signal detector circuit 316 more quickly recognize the resonant response 204 from the object 104.

The passive antenna 106 of the object 104 can be configured to receive the transmitted signal 202 and alter the transmitted signal 202. The passive antenna 106 can include a capacitor 404 and an inductor 406 to alter the transmitted signal 202 and transmit the altered transmitted signal 202 as a resonant response 204. The capacitor 404 and the inductor 406 of the passive antenna 106 can be altered to change an amount of change detectable in the resonant response 204 relative to the transmitted signal 202.

The signal receiver 122 can be configured to receive the resonant response 204. The signal receiver 122 can include a signal receiver 122 and a signal detector circuit 316. The signal receiver 122 can be configured to capture signals within a set frequency range such that it would only receive signals that could potentially be the resonant response 204. The signal detector circuit 316 can be configured to analyze the signals received by the signal receiver 122 and compare the received signals with the signals sent by the signal generator 120. The signal detector circuit 316 can be in communication with one or more systems to predict the transformation of the external radio frequency signal between the transmitted signal 202 and the resonant response 204 based on the capacitor 404 and the inductor 406 of the passive antenna 106 installed in the object 104.

The transformation of the transmitted signal 202 to the resonant response 204 by the passive antenna 106 can be called the ring-down effect of the passive antenna 106. As such, the signal detector circuit 316 can monitor the external radio frequency signals received by the signal receiver 122 looking for the ring-down signal matching the resonant response 204 (based on comparing the resonant response 204 to the reflected external radio frequency signal 310, see FIG. 3). Once the signal is detected, the portable detector unit 102 can include one or more additional components to determine a location of the object 104 relative to the portable detector unit 102. These components will be discussed in more detail herein.

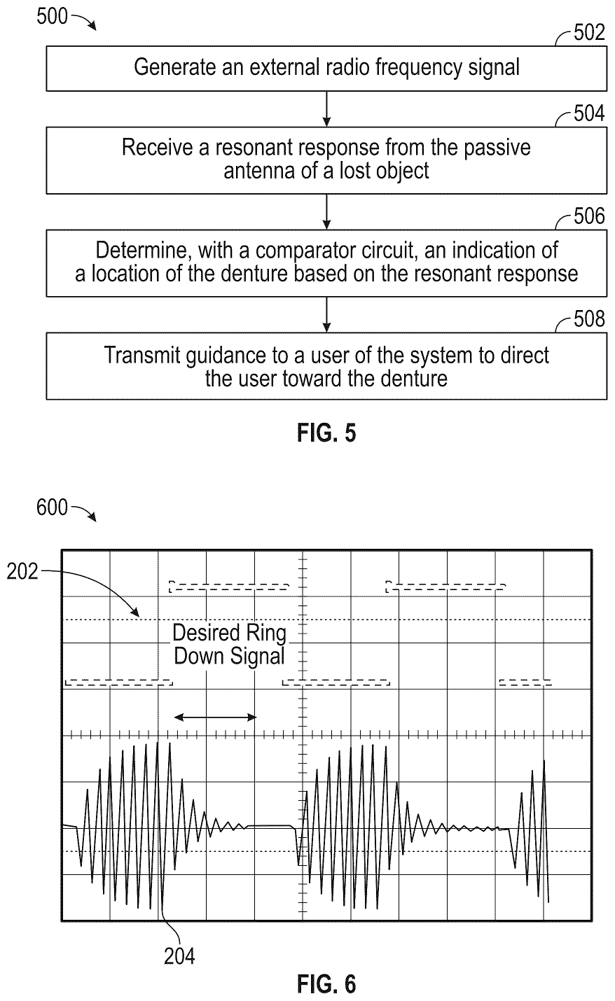

FIG. 5 illustrates an example of portions of a method 500 for finding an object (e.g., object 104, see FIG. 1) with a portable detector unit (e.g., the portable detector unit 102, see FIG. 1). Although the example of the method 500 depicts a particular sequence of operations, the sequence may be altered without departing from the scope of the present disclosure. For example, some of the operations depicted may be performed in parallel or in a different sequence that does not materially affect the function of the method 500. In other examples, different components of an example device or system that implements the method 500 may perform functions at substantially the same time or in a specific sequence. Moreover, the method 500 can include additional operations or can omit one or more of operations 502 - 508.

According to some examples, the method 500 can include generating an external radio frequency signal at operation 502. The external radio frequency signal can be generated by the portable detector unit (e.g., the portable detector unit 102, see FIG. 1). As discussed herein, the external radio frequency signal can be altered as the user attempts to find the object. For example, the amplitude, frequency, or intensity of the external radio frequency signal can be adjusted to find the object.

According to some examples, the method 500 can include receiving a resonant response from the passive antenna (e.g., the passive antenna 106, see FIG. 1) of a lost object (e.g., the object 104, see FIG. 1) at operation 504. The resonant response can be received by a receive amplifier (e.g., receiving antenna 312, shown in FIG. 3) of the signal receiver (e.g., the signal receiver 122, FIG. 1).

According to some examples, the method 500 can include determining, with a comparator circuit (e.g., comparator circuit 302, shown in FIG. 3), an indication of a location of the denture based on the resonant response at operation 506. As discussed herein, the resonant response can be set based on the passive antenna installed within the object. The portable detector unit can retrieve the anticipated resonant response via a database or can receive a reflected signal from the signal generator. As the comparator circuit can anticipate how the passive antenna will alter the external radio frequency signal in the resonant response, the comparator circuit can determine when the resonant response is detected.

According to some examples, the method can include transmitting guidance to an end-user of the system to direct the user toward the denture at operation 508. The comparator circuit can compare the reflected external radio frequency signal and the resonant response to determine the location of the portable detector unit relative to the lost object. Based on the location of the portable detector unit relative to the lost object, the comparator circuit can transmit a guidance signal to the user interface to guide the user toward the lost object. The method 500 will be discussed in more detail herein.

FIG. 6 illustrates a graphical representation 600 of an example of a ring-down signal. As shown in the graphical representation 600, the transmitted signal 202 can include pulsing at set intervals. The intervals at which the transmitted signal 202 is pulsed help predict the resonant response 204. For example, as the transmitted signal 202 terminates, the resonant response 204 attenuates. The attenuation of the resonant response 204 matching the termination of the transmitted signal 202 helps the signal detector circuit 316 (FIG. 4) detect the resonant response 204.

In other words, the handheld detector can utilize a hybridized approach blending RFID principles, harmonic resonant frequency detection, and short-pulse RLC (resistor, inductor, capacitor) “ring-down” response technique. This hybrid approach can address the limitations of RFID-only and harmonic reflector-only systems. The handheld detector can switch between modes based on the search environment, including complexity and RF “cleanliness”. This flexibility can allow for more effective detection in various settings.

The system can employ a “Ring-Down” concept, optionally blended with harmonic reflector technology. It can use a short dipole antenna with negative reactance, matched with inductance to cancel reactance and maximize power transfer to load. This approach can create an RLC circuit that can be excited by radiated RF E-field pulses.

The handheld detector can “listen” for the RLC “ring-down” after removing the incident RF. This can allow for identification of the denture tag's specific response, which can be characterized by its Q-Factor and damping properties, which can improve detection range and accuracy.

The user interface can be designed to be simple and intuitive, requiring less manual adjustment. The software can automatically adjust RF parameters and switch between search methods based on real-time calculations of the estimated range of the tag.

The denture tag can employ specific antenna trimming approaches tailored to the size and form factor of the denture. This can include folding of antennas and end trimming without significant effects on range. The tag can be designed to be completely passive, without any active power source, for safe integration into the denture.

The denture detector can employ multiple internal antennas at differing orientations to support specific transceiver operations. This can include multiple circuits for each search method, not just for addressing nulls or polarization issues.

The operational guidance software can instruct the operator on sequential movements to sweep the environment when the tag is out of range, allowing for effective searches in larger areas.

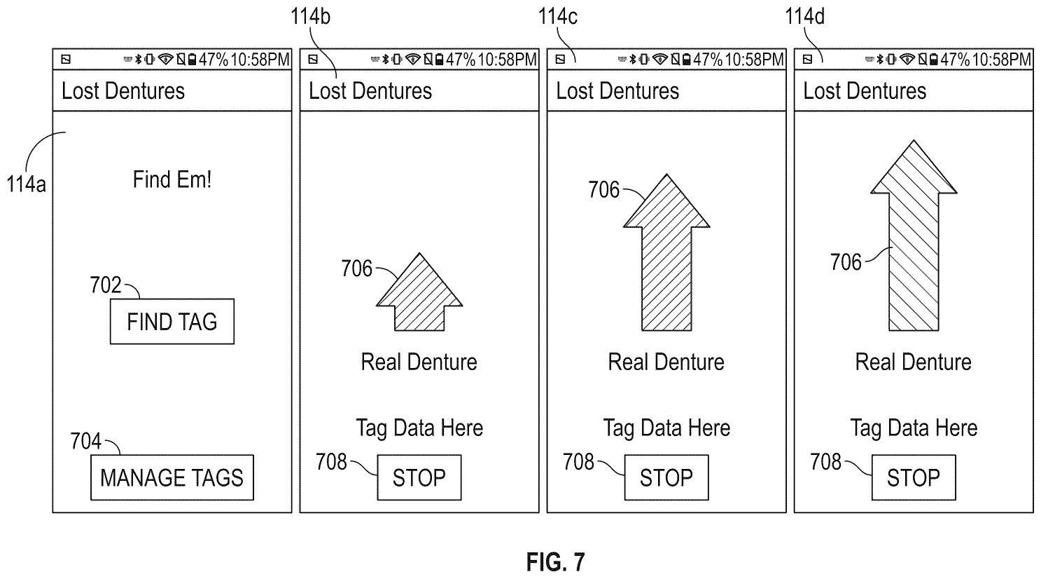

FIG. 7 illustrates examples of portions of the user interfaces (114a-114d) on the portable detector units 102. The user interface 114a is an example user interface when the device (e.g., the portable detector unit 102, see FIG. 1) is turned on and ready to find a lost object (e.g., object 104, see FIG. 1). The user of the portable detector unit 102 can select a find a tag button 702 or the manage tag button 704. The find a tag button 702 can initiate the system to generate an external radio frequency signal to find the lost object. The manage tag button 704 can prompt a settings window that permits the user to update, add, or remove tagged devices (e.g., object 104, FIG. 1).

The user interfaces 114b - 114d can be an example of a user interface as the portable detector unit 102 is searching for the object 104. The user interfaces 114b - 114d can include a signal-finding guidance 706 and a stop searching button 708. The stop searching button 708 can help guide the user of the portable detector unit 102 toward the object 104. The signal-finding guidance 706 can include both magnitude (e.g., a length of the indicia) and directional (e.g., a direction the object 104 is relative to the portable detector unit 102) information to help the user find the object 104. As shown in FIG. 7, the signal-finding guidance 706 can also include pattern, color, or one or more other visual indicia to indicate when the object 104 is detected by the portable detector unit 102. For example, as shown in user interface 114b and user interface 114c, the portable detector unit 102 shows an example when the portable detector unit 102 has not detected the presence of the object 104. The example shown in user interface 114d shows an example in which the portable detector unit 102 has detected the presence of the object 104. In addition to the visual indicia, the object 104 can generate haptic feedback, audible feedback, or the like to indicate various steps of the operation (e.g., searching has started, the portable detector unit 102 detects the presence of the object 104, the portable detector unit 102 detects that the object 104 is moving, or the like) to inform the user of the portable detector unit 102.

The stop searching button 708 can indicate to the portable detector unit 102 that the user wants to end the search for object 104. As the stop searching button 708 is pressed, user interface 114a can be shown on the portable detector unit 102 such that the user can either select a new tag (e.g., missing object 104) or adjust the portable detector unit 102 via the settings or other parameters.

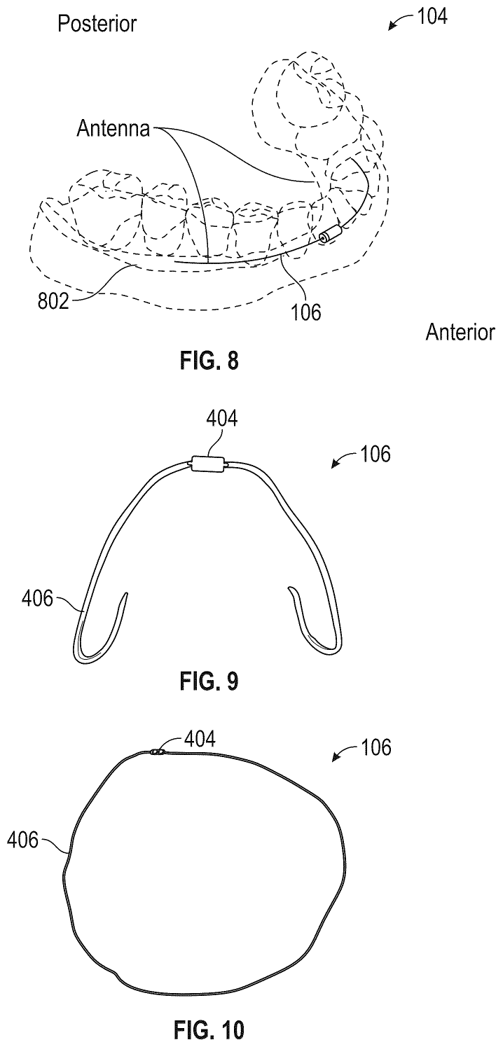

FIG. 8 illustrates an example of portions of the object 104. The object 104 can include an removable base 802. As shown in FIG. 8, the passive antenna 106 can be installed within the removable base 802 toward the front of the mouth. In another example, the passive antenna 106 can be installed anywhere within the removable base 802. In another example, the object 104 can include more than one of the passive antenna 106 installed throughout the removable base 802. In examples, at least a portion of the passive antenna 106 can be installed within the removable base 802 such that a portion of the passive antenna 106 extends outside of the removable base 802. The passive antenna 106 can extend within the prosthetic teeth. In examples, the passive antenna 106 can extend from an anterior portion of the removable base 802. In another example, the passive antenna 106 can extend from a posterior portion of the removable base 802.

FIG. 9 illustrates an example of the passive antenna 106. As discussed herein, the passive antenna 106 can include an integrated circuit, which can include the capacitor 404 and the inductor 406. The inductor 406 can extend from multiple sides of the capacitor 404 such that the passive antenna 106 is configured to match the contour of the object 104 (as shown in FIG. 8).

FIG. 10 illustrates an example of the passive antenna 106. As discussed herein, the passive antenna 106 can include the capacitor 404 and the inductor 406. The inductor 406 can extend from multiple sides of the capacitor 404 such that the inductor 406 forms a loop connecting the capacitor 404 to the capacitor 404. In such an example, the passive antenna 106 can be fit to the contour of the object 104 (as shown in FIG. 8).

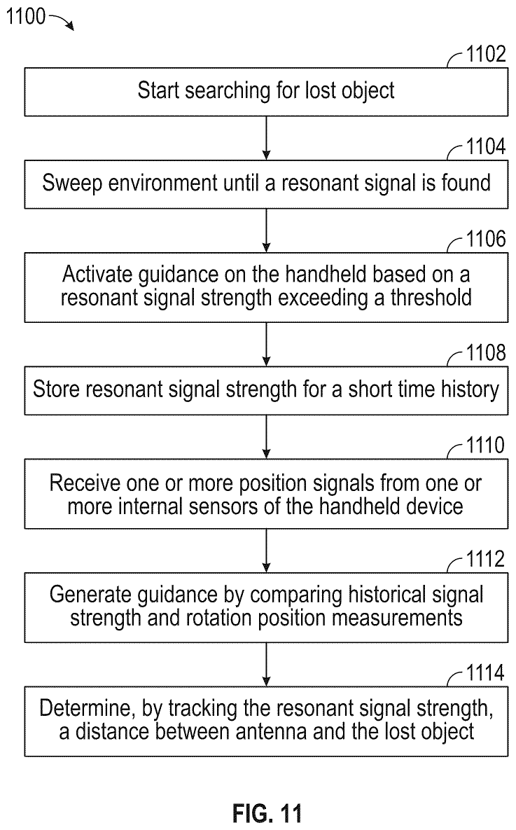

FIG. 11 illustrates a schematic diagram of an example method 1100 for operating a locating device (e.g., portable detector unit 102) to find a missing object (e.g., object 104). The method 1100 can include one or more of operations 1102-1114.

At operation 1102, the method 1100 can optionally include starting to search for a lost object. The user of the handheld device can initiate the search process using the locating device.

At operation 1104, the method 1100 can optionally include sweeping the environment until a resonant signal is found. This can involve moving the locating device around the search area to detect the signal from the lost object.

At operation 1106, the method 1100 can optionally include activating guidance on the handheld device based on a resonant signal strength exceeding a threshold. This can trigger the device to provide directional guidance to the user once a sufficiently strong signal is detected.

At operation 1108, the method 1100 can optionally include storing resonant signal strength for a short time history. This can allow the device to track changes in signal strength over time, which can be useful for determining direction and proximity.

At operation 1110, the method 1100 can optionally include receiving one or more position signals from one or more internal sensors of the handheld device. These sensors can provide information about the device's orientation and movement.

At operation 1112, the method 1100 can optionally include generating guidance by comparing historical signal strength and rotation position measurements. This can help determine the direction of the strongest signal and guide the user accordingly.

At operation 1114, the method 1100 can optionally include determining, by tracking the resonant signal strength, the distance between the antenna and the lost object. This can provide an estimate of how far away the object is from the locating device.

The method 1100 can be flexible in its implementation. The sequence of operations may be altered without departing from the scope of the disclosure. Some operations may be performed in parallel or in a different sequence that does not materially affect the function of the method.

Different components of the device or system implementing the method may perform functions at substantially the same time or in a specific sequence. This method 1100 can utilize various features of the locating device, such as its ability to switch between different detection modes based on the search environment, its use of multiple internal antennas, and its automatic adjustment of RF parameters. The method 1100 can also incorporate the device's user interface, which can provide visual, audio, and/or haptic feedback to guide the user during the search process.

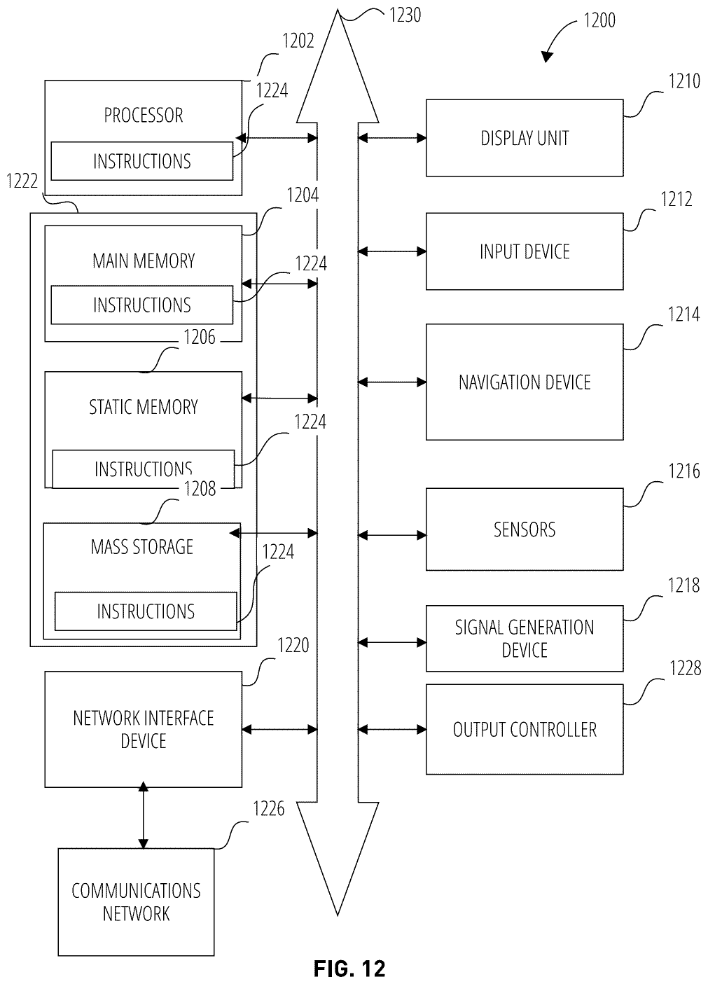

FIG. 12 illustrates a block diagram of an example machine 1200 upon which any techniques (e.g., methodologies) discussed herein can perform. As described herein, examples can include, or can operate by, logic or a number of components or mechanisms in the machine 1200. Circuitry (e.g., processing circuitry) is a collection of circuits implemented in tangible entities of machine 100, including hardware (e.g., simple circuits, gates, logic, etc.). Circuitry membership can be flexible over time. Circuitries include members that can, alone or in combination, perform specified operations when operating. In an example, hardware of the circuitry can be immutably designed to carry out a specific operation (e.g., hardwired). In an example, the hardware of the circuitry can include variably connected physical components (e.g., execution units, transistors, simple circuits, etc.), including a machine-readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuitry in hardware via the variable connections to carry out portions of the specific operation when in operation. Accordingly, in an example, the machine-readable medium elements are part of the circuitry or are communicatively coupled to the other circuitry components when the device is operating. In an example, any of the physical components can be used in more than one member of more than one circuitry. For example, under operation, execution units can be used in a first circuit of a first circuitry at one point in time and reused by a second circuit in the first circuitry or by a third circuit in a second circuitry at a different time. Additional examples of these components with respect to the machine 1200 follow.

In alternative examples, the machine 1200 can operate as a standalone device or be connected (e.g., networked) to other machines. In a networked deployment, the machine 1200 can operate in the capacity of a server machine, a client machine, or both in server-client network environments. In an example, the machine 1200 can act as a peer machine in peer-to-peer (P2P) (or other distributed) network environment. The machine 1200 can be a personal computer (PC), a tablet PC, a set-top box (STB), a personal digital assistant (PDA), a mobile telephone, a web appliance, a network router, switch, or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

The machine 1200 can include a hardware processor 1202 (e.g., a central processing unit (CPU), a graphics processing unit (GPU), a hardware processor core, or any combination thereof), a main memory 1204, a static memory (e.g., memory or storage for firmware, microcode, a basic-input-output (BIOS), and mass storage 1208 (e.g., hard drives, tape drives, flash storage, or other block devices) some or all of which can communicate with each other via an interlink 1230 (e.g., bus). The machine 1200 can further include a display unit 1210, an alphanumeric input device 1212 (e.g., a keyboard), and a user interface (UI) navigation device 1214 (e.g., a mouse). In examples, the display unit 1210, input device 1212 and UI navigation device 1214 can be a touch screen display. The machine 1200 can include a signal generation device 1218 (e.g., a speaker), a network interface device 1220, and one or more sensors 1216, such as a global positioning system (GPS) sensor, compass, accelerometer, or other sensor. The machine 1200 can include an output controller 1228, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

Registers of the processor 1202, the main memory 1204, the static memory 1206, or the mass storage 1208 can be, or include, a machine-readable medium 1222 on which is stored one or more sets of data structures or instructions 1224 (e.g., software) embodying or utilized by any one or more of the techniques or functions described herein. The instructions 1224 can also reside, completely or at least partially, within any of the registers of the processor 1202, the main memory 1204, the static memory 1206, or the mass storage 1208 during execution by the machine 1200. Any combination of the hardware processor 1202, the main memory 1204, the static memory 1206, or the mass storage 1208 can constitute the machine-readable media 1222. While the machine-readable medium 1222 is illustrated as a single medium, “machine-readable medium” can include a single medium or multiple media (e.g., a centralized or distributed database or associated caches and servers) configured to store one or more instructions 1224.

The term “machine-readable medium” can include any medium that is capable of storing, encoding, or carrying instructions for execution by the machine 1200 and that causes the machine 1200 to perform any one or more of the techniques of the present disclosure, or that is capable of storing, encoding or carrying data structures used by or associated with such instructions. Non-limiting machine-readable medium examples can include solid-state memories, optical media, magnetic media, and signals (e.g., radio frequency signals, other photon-based signals, sound signals, etc.). A non-transitory machine-readable medium comprises a machine-readable medium with a plurality of particles having invariant (e.g., rest) mass and, thus, are compositions of matter. Accordingly, non-transitory machine-readable media are machine-readable media that do not include transitory propagating signals. Specific examples of non-transitory machine-readable media can include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

Information stored or otherwise provided on the machine-readable medium 1222 can represent instructions 1224, such as instructions 1224 themselves or a format from which the instructions 1224 can be derived. This format from which the instructions 1224 can be derived can include source code, encoded instructions (e.g., in compressed or encrypted form), packaged instructions (e.g., split into multiple packages), or the like. The information representative of the instructions 1224 in the machine-readable medium 1222 can be processed by processing circuitry into the instructions to implement any of the operations discussed herein. For example, deriving the instructions 1224 from the information (e.g., processing by the processing circuitry) can include compiling (e.g., from source code, object code, etc.), interpreting, loading, organizing (e.g., dynamically or statically linking), encoding, decoding, encrypting, unencrypting, packaging, unpackaging, or otherwise manipulating the information into the instructions 1224.

In an example, the derivation of the instructions 1224 can include assembly, compilation, or interpretation of the information (e.g., by the processing circuitry) to create the instructions 1224 from some intermediate or preprocessed format provided by the machine-readable medium 1222. When provided in multiple parts, the information can be combined, unpacked, and modified to create the instructions 1224. For example, the information can be in multiple compressed source code packages (object code, binary executable code, etc.) on one or several remote servers. The source code packages can be encrypted when in transit over a network and decrypted, uncompressed, assembled (e.g., linked) if necessary, and compiled or interpreted (e.g., into a library, stand-alone executable, etc.) at a local machine, and executed by the local machine.

The instructions 1224 can be further transmitted or received over a communications network 1226 using a transmission medium via the network interface device 1220 utilizing any one of several transfer protocols (e.g., frame relay, internet protocol (IP), transmission control protocol (TCP), user datagram protocol (UDP), hypertext transfer protocol (HTTP), etc.). Example communication networks can include a local area network (LAN), a wide area network (WAN), a packet data network (e.g., the Internet), LoRa/LoRaWAN, or satellite communication networks, mobile telephone networks (e.g., cellular networks such as those complying with 3G, 4G LTE/LTE-A, or 5G standards), Plain Old Telephone (POTS) networks, and wireless data networks (e.g., Institute of Electrical and Electronics Engineers (IEEE) 802.11 family of standards known as Wi-Fi®, IEEE 802.15.4 family of standards, peer-to-peer (P2P) networks, among others. The network interface device 1220 can include one or more physical jacks (e.g., Ethernet, coaxial, or phone jacks) or one or more antennas to connect to the communications network 1226. The network interface device 1220 can include a plurality of antennas to wirelessly communicate using at least one of single-input multiple-output (SIMO), multiple-input multiple-output (MIMO), or multiple-input single-output (MISO) techniques. The term “transmission medium” shall include any intangible medium capable of storing, encoding or carrying instructions for execution by the machine 1200, and includes digital or analog communications signals or other intangible medium to facilitate communication of such software. A transmission medium is a machine-readable medium.

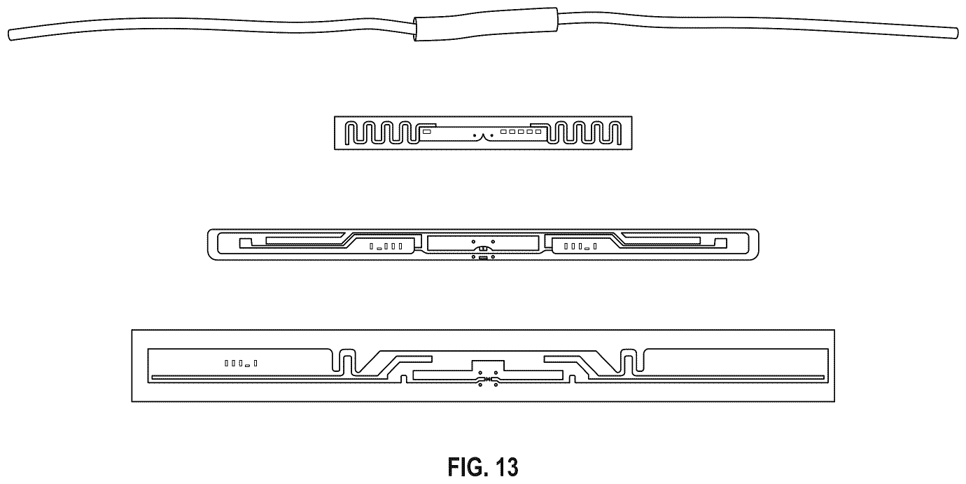

FIG. 13 illustrates one or more examples of a passive antenna (e.g., the passive antenna 106, FIG. 1). As the other versions of the passive antenna discussed herein, these are non-limiting examples of the types of tags that can be used as passive antennas within the objects.

The following non-limiting examples detail certain aspects of the present subject matter that solve the challenges and provide the benefits discussed herein, among other things.

Example 1 is a system for helping an end-user locate a denture including a passive antenna, the passive antenna embedded within the denture and configured to generate a resonant response by resonating at a resonance frequency when subjected to an external radio frequency signal, the system comprising: a portable detector unit configured to emit the external radio frequency signal and to detect the resonant response from the passive antenna, the portable detector unit including: a signal generator to generate and transmit the external radio frequency signal; a signal receiver to receive the resonant response from the passive antenna within the denture; memory including instructions; and a controller coupled to the memory, the instructions, when performed by processing circuitry of the controller, are configured to cause the processing circuitry to perform operations including: determine, based on the resonant response, an indication of a location of the denture; and transmit guidance to a user of the system to direct the user toward the denture.

In Example 2, the subject matter of Example 1 optionally includes wherein the passive antenna includes: a capacitor; and a wire loop acting as an inductor and connected to the capacitor, the capacitor and the wire loop determine the resonance frequency of resonation for the passive antenna within the denture.

In Example 3, the subject matter of any one or more of Examples 1-2 optionally include wherein the signal generator is configured to generate the external radio frequency signal in a pulse transmitted at a specific interval.

In Example 4, the subject matter of Example 3 optionally includes wherein the signal generator comprises: a comparator circuit configured to transform the external radio frequency signal into a sine wave; a radio frequency amplifier to amplify the external radio frequency signal; and a radio frequency switch to alter a frequency of the external radio frequency signal.

In Example 5, the subject matter of Example 4 optionally includes wherein the instructions are configured to cause the controller to: reduce, using the comparator circuit, noise in the external radio frequency signal; adjust, using the radio frequency amplifier, an intensity of the external radio frequency signal; and alter, using the radio frequency switch, the frequency of the external radio frequency signal.

In Example 6, the subject matter of any one or more of Examples 1-5 optionally include wherein the signal generator is configured to generate the external radio frequency signal continuously while the portable detector unit is in operation.

In Example 7, the subject matter of Example 6 optionally includes wherein the signal generator comprises: a comparator circuit configured to transform the external radio frequency signal into a sine wave; a radio frequency amplifier to amplify the external radio frequency signal; and a radio frequency switch to alter a frequency of the external radio frequency signal.

In Example 8, the subject matter of Example 7 optionally includes wherein the instructions are configured to cause the controller to: reduce, using the comparator circuit, noise in the external radio frequency signal; adjust, using the radio frequency amplifier, an intensity of the external radio frequency signal; and alter, using the radio frequency switch, the frequency of the external radio frequency signal.

In Example 9, the subject matter of any one or more of Examples 1-8 optionally include wherein the signal generator comprises: a harmonic reflector configured to: receive the external radio frequency signal; generate a reflected external radio frequency signal; and transmit the reflected external radio frequency signal to the signal receiver.

In Example 10, the subject matter of any one or more of Examples 1-9 optionally include wherein the signal receiver comprises: an antenna configured to receive the resonant response; a receive amplifier to generate an amplified resonant response signal; and a detector circuit to generate a digital response signal indicative of the amplified resonant response signal.

In Example 11, the subject matter of Example 10 optionally includes wherein the system includes a database configured to store template resonant response signals for corresponding passive antennas, and wherein the instructions are configured to cause the controller to: compare the digital resonant response signal to one or more of the template resonant response signals; and generate an alert on condition that the digital response signal matches at least one of the template resonant response signals.

In Example 12, the subject matter of any one or more of Examples 1 -11 optionally include wherein the portable detector unit comprises: a user interface including a display to provide visual guidance to the user of the system based on the determined indication of the location of the denture relative to the portable detector unit.

In Example 13, the subject matter of Example 12 optionally includes wherein the user interface provides at least one of audible or haptic feedback to assist the user in locating the denture.

In Example 14, the subject matter of any one or more of Examples 12-13 optionally include wherein on condition that the resonant response is not received by the signal receiver, the instructions cause the processing circuitry to perform operations including: transmit signal-finding guidance to the user via the user interface to direct the user to sweep an environment until the resonant response is detected by the signal receiver.

In Example 15, the subject matter of any one or more of Examples 1-14 optionally include wherein the portable detector unit comprises: a rechargeable power source; and an inductive charging interface to provide a charge to the portable detector unit, wirelessly.

In Example 16, the subject matter of any one or more of Examples 1-15 optionally include wherein the portable detector unit is configured to distinguish between multiple dentures, each denture of the multiple dentures including the passive antenna.

In Example 17, the subject matter of Example 16 optionally includes wherein the passive antenna for each denture of the multiple dentures is configured to resonate at a respective frequency when subjected to the external radio frequency signal from the portable detector unit, each respective frequency for each denture of the multiple dentures different than other respective frequencies of the other dentures of the multiple dentures.

In Example 18, the subject matter of any one or more of Examples 1-17 optionally include wherein the passive antenna includes a radio frequency identification (RFID).

Example 19 is a system comprising: a denture including a passive antenna, the passive antenna embedded within the denture and configured to generate a resonant response by resonating at a resonance frequency when subjected to an external radio frequency signal; and a portable detector unit configured to emit the external radio frequency signal and to detect the resonant response from the passive antenna, the portable detector unit including: a signal generator to generate and transmit the external radio frequency signal; a signal receiver to receive the resonant response from the passive antenna within the denture; memory including instructions; and a controller coupled to the memory, the instructions, when performed by processing circuitry of the controller, are configured to cause the processing circuitry to perform operations including: determine, based on the resonant response, an indication of a location of the denture; and transmit guidance to a user of the system to direct the user toward the denture.

In Example 20, the subject matter of Example 19 optionally includes wherein the signal generator comprises: a comparator circuit configured to transform the external radio frequency signal into a sine wave; a radio frequency amplifier to amplify the external radio frequency signal; and a radio frequency switch to alter a frequency of the external radio frequency signal; wherein the instructions are configured to cause the controller to: reduce, using the comparator circuit, noise in the external radio frequency signal; adjust, using the radio frequency amplifier, an intensity of the external radio frequency signal; and alter, using the radio frequency switch, the frequency of the external radio frequency signal.

Example 21 can include a system, apparatus, device, method, or computer-readable medium including any element of any of Examples 1-20.

1The above detailed description includes references to the accompanying drawings, which form a part of the detailed description. The drawings show, by way of illustration, specific examples that may be practiced. These embodiments are also referred to herein as “examples.”Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more. ” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. 1Moreover, in the following claims, the terms “first,” “second,” and “third,” etc. are used merely as labels, and are not intended to impose numerical requirements on their objects.

The term “about,” as used herein, means approximately, in the region of, roughly, or around. When the term “about” is used in conjunction with a numerical range, it modifies that range by extending the boundaries above and below the numerical values set forth. In general, the term “about” is used herein to modify a numerical value above and below the stated value by a variance of 10%. In one aspect, the term “about” means plus or minus 10% of the numerical value of the number with which it is being used. Therefore, about 50% means in the range of 45%-55%. Numerical ranges recited herein by endpoints include all numbers and fractions subsumed within that range (e.g., 1 to 5 includes 1, 1.5, 2, 2.75, 3, 3.90, 4, 4.24, and 5). Similarly, numerical ranges recited herein by endpoints include subranges subsumed within that range (e.g., 1 to 5 includes 1-1.5, 1.5-2, 2-2.75, 2.75-3, 3-3.90, 3.90-4, 4-4.24, 4.24-5, 2-5, 3-5, 1-4, and 2-4). It is also to be understood that all numbers and fractions thereof are presumed to be modified by the term “about.”

The above description is intended to be illustrative, and not restrictive. For example, the above-described examples (or one or more aspects thereof) may be used in combination with each other. Other examples may be used, such as by one of ordinary skill in the art upon reviewing the above description. The Abstract is to allow the reader to quickly ascertain the nature of the technical disclosure and is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the examples should be determined with reference to the appended claims, along with the full scope of equivalents to which such claims are entitled.

What is claimed is:

1. A system for helping an end-user locate a denture including a passive antenna, the passive antenna embedded within the denture and configured to generate a resonant response by resonating at a resonance frequency when subjected to an external radio frequency signal, the system comprising:
a portable detector unit configured to emit the external radio frequency signal and to detect the resonant response from the passive antenna, the portable detector unit including:
a signal generator to generate and transmit the external radio frequency signal;
a signal receiver to receive the resonant response from the passive antenna within the denture;
memory including instructions; and
a controller coupled to the memory, the instructions, when performed by processing circuitry of the controller, are configured to cause the processing circuitry to perform operations including:
determine, based on the resonant response, an indication of a location of the denture; and
transmit guidance to a user of the system to direct the user toward the denture.

2. The system of claim 1, wherein the passive antenna includes:
a capacitor; and
a wire loop acting as an inductor and connected to the capacitor, the capacitor and the wire loop determine the resonance frequency of resonation for the passive antenna within the denture.

3. The system of claim 1, wherein the signal generator is configured to generate the external radio frequency signal in a pulse transmitted at a specific interval.

4. The system of claim 3, wherein the signal generator comprises:
a comparator circuit configured to transform the external radio frequency signal into a sine wave;
a radio frequency amplifier to amplify the external radio frequency signal; and
a radio frequency switch to alter a frequency of the external radio frequency signal.

5. The system of claim 4, wherein the instructions are configured to cause the controller to:
reduce, using the comparator circuit, noise in the external radio frequency signal;
adjust, using the radio frequency amplifier, an intensity of the external radio frequency signal; and
alter, using the radio frequency switch, the frequency of the external radio frequency signal.

6. The system of claim 1, wherein the signal generator is configured to generate the external radio frequency signal continuously while the portable detector unit is in operation.

7. The system of claim 6, wherein the signal generator comprises:
a comparator circuit configured to transform the external radio frequency signal into a sine wave;
a radio frequency amplifier to amplify the external radio frequency signal; and
a radio frequency switch to alter a frequency of the external radio frequency signal.

8. The system of claim 7, wherein the instructions are configured to cause the controller to:
reduce, using the comparator circuit, noise in the external radio frequency signal;
adjust, using the radio frequency amplifier, an intensity of the external radio frequency signal; and
alter, using the radio frequency switch, the frequency of the external radio frequency signal.

9. The system of claim 1, wherein the signal generator comprises:
a harmonic reflector configured to:
receive the external radio frequency signal;
generate a reflected external radio frequency signal; and
transmit the reflected external radio frequency signal to the signal receiver.

10. The system of claim 1, wherein the signal receiver comprises:
an antenna configured to receive the resonant response;
a receive amplifier to generate an amplified resonant response signal; and
a detector circuit to generate a digital response signal indicative of the amplified resonant response signal.

11. The system of claim 10, wherein the system includes a database configured to store template resonant response signals for corresponding passive antennas, and wherein the instructions are configured to cause the controller to:
compare the digital resonant response signal to one or more of the template resonant response signals; and
generate an alert on condition that the digital response signal matches at least one of the template resonant response signals.

12. The system of claim 1, wherein the portable detector unit comprises:
a user interface including a display to provide visual guidance to the user of the system based on the determined indication of the location of the denture relative to the portable detector unit.

13. The system of claim 12, wherein the user interface provides at least one of audible or haptic feedback to assist the user in locating the denture.

14. The system of claim 12, wherein on condition that the resonant response is not received by the signal receiver, the instructions cause the processing circuitry to perform operations including:
transmit signal-finding guidance to the user via the user interface to direct the user to sweep an environment until the resonant response is detected by the signal receiver.

15. The system of claim 1, wherein the portable detector unit comprises:
a rechargeable power source; and
an inductive charging interface to provide a charge to the portable detector unit, wirelessly.

16. The system of claim 1, wherein the portable detector unit is configured to distinguish between multiple dentures, each denture of the multiple dentures including the passive antenna.

17. The system of claim 16, wherein the passive antenna for each denture of the multiple dentures is configured to resonate at a respective frequency when subjected to the external radio frequency signal from the portable detector unit, each respective frequency for each denture of the multiple dentures different than other respective frequencies of the other dentures of the multiple dentures.

18. The system of claim 1, wherein the passive antenna includes a radio frequency identification (RFID).

19. A system comprising:
a denture including a passive antenna, the passive antenna embedded within the denture and configured to generate a resonant response by resonating at a resonance frequency when subjected to an external radio frequency signal; and
a portable detector unit configured to emit the external radio frequency signal and to detect the resonant response from the passive antenna, the portable detector unit including:
a signal generator to generate and transmit the external radio frequency signal;
a signal receiver to receive the resonant response from the passive antenna within the denture;
memory including instructions; and
a controller coupled to the memory, the instructions, when performed by processing circuitry of the controller, are configured to cause the processing circuitry to perform operations including:
determine, based on the resonant response, an indication of a location of the denture; and
transmit guidance to a user of the system to direct the user toward the denture.

20. The system of claim 19, wherein the signal generator comprises:
a comparator circuit configured to transform the external radio frequency signal into a sine wave;
a radio frequency amplifier to amplify the external radio frequency signal; and
a radio frequency switch to alter a frequency of the external radio frequency signal;
wherein the instructions are configured to cause the controller to:
reduce, using the comparator circuit, noise in the external radio frequency signal;
adjust, using the radio frequency amplifier, an intensity of the external radio frequency signal; and
alter, using the radio frequency switch, the frequency of the external radio frequency signal.
